(19) United States
(12) Patent Application Publication
(10) Pub. No.: US 2023/0229727 A1
(43) Pub. Date: Jul. 20, 2023

(54) ISING MACHINE BASED ON COUPLED BISTABLE NODES FOR SOLVING COMBINATORIAL PROBLEMS

(71) Applicant: University of Rochester, Rochester, NY (US)

(72) Inventors: Zeljko Ignjatovic, Rochester, NY (US); Michael Huang, Pittsford, NY (US); Richard Afoakwa, Beltsville, MD (US)

(21) Appl. No.: 17/996,283

(22) PCT Filed: Apr. 16, 2021
(86) PCT No.: PCT/US21/70402

§ 371 Date: Oct. 14, 2022

Related U.S. Application Data
(60) Provisional application No. 63/011,245, filed on Apr. 16, 2020.

(51) Int. Cl. G06F 17/11

(52) U.S. Cl. CPC G06F 17/11

(57) ABSTRACT

An Ising machine having a network of resistively coupled circuit nodes where at least one node comprises a capacitor whose voltage between its terminals represents a state variable of the node and the voltage is resistively coupled to at least one other node in the network and a two-terminal active electronics element connected in parallel with the capacitor supplying energy to the node, and the element having an odd-symmetric current-voltage characteristic exhibiting a negative current gradient for voltages across its terminals that are below a predetermined threshold value in magnitude, and a positive gradient otherwise and zero current for three voltage instances: zero volts, +V₁ volts, and −V₁ volts, where V₁ is a constant greater than the predetermined threshold.

### CROSS-REFERENCE TO RELATED APPLICATION

This application claims the benefit under 35 U.S.C. § 119(e) of the following U.S. provisional patent application, which is incorporated by reference herein:

U.S. Provisional Patent Application No. 63/011,245, filed Apr. 16, 2020, and entitled “ISING MACHINE BASED ON COUPLED BISTABLE NODES FOR SOLVING COMBINATORIAL PROBLEMS,” by Ignjatovic et al. (Attorney Docket No. URNVP001.P1).

### BACKGROUND OF THE INVENTION

### 1. Field of the Invention

This invention relates to Ising machines. Particularly, this invention relates to Ising machines implemented with a network of resistively coupled circuit nodes where a node has a capacitor connected in parallel with an active electronics element.

### 2. Description of the Related Art

The power of computing machinery has improved by orders of magnitude over the past decades. Over the same period, the need for computation has been spurred by the improvement and continues to require better mechanisms to solve a wide array of modern problems. For a long time, the industry focused on improving general-purpose computing systems. In recent years, special purpose designs have been increasingly adopted for their efficacy in certain type of tasks such as encryption and network operations.

More recently, machine learning tasks have become a new focus and many specialized architectures are proposed to accelerate these operations. Much of this work has been directed to constructing a more efficient architecture where the control overhead as well as the cost of operation becomes much lower than traditional designs.

In a related but different track of work, researchers are trying to map an entire algorithm to physical processes such that the resulting state represents an answer to the mapped algorithm. Quantum computers marketed by D-Wave Systems are prominent examples. Different from circuit model quantum computers, D-Wave machines perform quantum annealing. (Bunyk et al., “Architectural considerations in the design of a superconducting quantum annealing processor,” IEEE Transactions on Applied Superconductivity, 24(4):1-10, 2014, which is incorporated by reference herein.) The idea is to map a combinational optimization problem to a system of qubits such the that the system's energy maps to the metric of minimization. Then when the system naturally settles down to a ground state, the state of qubits can be read out, which points to the solution of the mapped problem.

It is as yet not definitive whether D-Wave's systems can reach some sort of quantum speedup. But one thing is clear: machines like these can indeed find some good solutions of an optimization problem, and in a very short amount of time too. Indeed, a number of alternative designs have emerged recently all showing good quality solutions for non-trivial sizes (sometimes discovering better results than the best known answer from all prior attempts) in milli- or micro-second latencies. (Inagaki et al. “A coherent ising machine for 2000-node optimization problems,” Science, 354(6312):603-606, 2016; Wang et al., “Oim: Oscillator-based ising machines for solving combinatorial optimisation problems,” In International Conference on Unconventional Computation and Natural Computation, pages 232-256, June 2019; and Roques-Carmes et al., “Heuristic recurrent algorithms for photonic ising machines,” Nature Communications, 11(1):249, 2020.) These prior art systems all share the property that a problem can be mapped to the machine's setup and then the machine's state evolves according to the physics of the system. This evolution has the effect of optimizing a particular formula called the Ising model. Reading out the state of such a system at the end of the evolution thus has the effect of obtaining a solution (usually a very good one) to the problem mapped.

For example, in some systems, the Hamiltonian is closely related to the Ising formula. Naturally, the system seeks to enter a low-energy state. In other systems, a Lyapunov function of the system can be shown to be related to the Ising formula. In general, these systems can be thought of as optimizing an objective function (in the form of the Ising formula) due to the physics. Hence, they are generally referred to as Lying machines. Clearly, unlike in a von Neumann machine, there is no explicit algorithm to follow. Instead, nature is effectively carrying out the computation. Ising machines have been implemented in a variety of ways with very different (and often complex) physics principles involved. It may not be clear whether some Ising machine form has a fundamental advantage that will manifest in a very large scale.

There is no guarantee that an Ising machine system will achieve ground state in practice, although a theoretical guarantee in some generally unachievable ideal setup may exist. For example, adiabatic quantum computing theory indicates that when the annealing schedule is sufficiently slow and in the absence of noise (i.e. at zero kelvin) the system is guaranteed to stay in the ground state. Consequently, there is no guarantee the corresponding answer is the best of all possible cases. Nonetheless, the speed and energy efficiency with which the Ising maching system finds a good answer are very attractive.

As exploration of this area is still relatively new, with newer methods being developed constantly, there is clearly a need for a CMOS-based Ising machine design which is much more amenable to on-chip integration than other designs. There is further a need for an Ising machine design that is fast and energy-efficient compared to prior designs and equally reliable in producing high-quality results. These and other needs are met by the present invention as detailed hereafter.

### SUMMARY OF THE INVENTION

Ising machines use physics to naturally guide a dynamical system towards an optimal state which can be read out as a heuristical solution to a combinational optimization problem. Such designs that use nature as a computing mechanism can lead to higher performance and/or lower operation costs. Quantum annealers are a prominent existing example of such machines. However, existing Ising machines are generally bulky and energy intensive. Such disadvantages might lead to intrinsic advantages at some larger scale in the future. But for now, integrated circuit designs allow more immediate applications. Embodiments of the present invention are directed to a design that uses bistable nodes, coupled with programmable and variable strength. The design is fully CMOS compatible for on-chip applications and demonstrate competitive metrics in performance, area, and energy.

An exemplary embodiment of the invention can comprise a network of resistively coupled circuit nodes having at least one node including a capacitor where a voltage across the capacitor represents a state variable of the node and the voltage is resistively coupled to at least one other node in the network and an active electronics element having two terminals connected in parallel with the capacitor supplying energy to the node, the active electronics element having an odd-symmetric current-voltage characteristic exhibiting: a negative current gradient for voltages across the two terminals that are below a predetermined threshold value in magnitude, and a positive gradient otherwise; and zero current for three voltage instances: zero volts, +V₁ volts, and −V₁ volts, where V₁ is a constant greater than the predetermined threshold. Further embodiments can include a programmable resistor connected in parallel with the active electronics element to adjust the negative current gradient and the positive current gradient in the odd-symmetric current-voltage characteristic and V₁. Further embodiments can include a bipolar junction transistor connected in parallel with the active electronics element to adjust the negative current gradient and the positive current gradient in the odd-symmetric current-voltage characteristic and V₁ by changing a base current of the bipolar junction transistor. Further embodiments can include a field-effect transistor connected in parallel with the active electronics element to adjust the negative current gradient and the positive current gradient in the odd-symmetric current-voltage characteristic and V₁ by changing a gate voltage of the field-effect transistor.

Another embodiment of the invention can comprise a network of coupled circuit nodes having at least one node including a capacitor where a voltage across the capacitor represents a state variable of the node and the voltage is converted to current before being coupled to at least one other node in the network and an active electronics element having two terminals connected in parallel with the capacitor supplying energy to the node, and the element having an odd-symmetric current-voltage characteristic exhibiting: a negative current gradient for voltages across the two terminals that are below a predetermined threshold value in magnitude, and a positive gradient otherwise; and zero current for three voltage instances: zero volts, +V₁ volts, and −V₁ volts, where V₁ is a constant greater than the predetermined threshold. This embodiment of the invention can be further modified consistent with any other networks, devices or methods described herein.

An exemplary method for solving maximum-cut problems on a graph can comprise mapping vertices of the graph are to nodes in a network of resistively coupled circuit nodes; and mapping edge weights of the graph to coupling resistors of the network, the network having: at least one node including: a capacitor where a voltage across the capacitor represents a state variable of the node and the voltage is resistively coupled to at least one other node in the network; and an active electronics element having two terminals connected in parallel with the capacitor supplying energy to the node, and the active electronics element having an odd-symmetric current-voltage characteristic exhibiting: a negative current gradient for voltages across its terminals that are below a predetermined threshold value in magnitude, and a positive gradient otherwise; and zero current for three voltage instances: zero volts, +V₁ volts, and −V₁ volts, where V₁ is a constant greater than the predetermined threshold. The method can further include a coupling resistor between any two nodes in the network corresponding to two vertices on the graph is inversely proportional to the edge weight between the two vertices, any two nodes in the network corresponding to positively connected vertices on the graph (i.e., positive edge weight) are cross-coupled connecting the terminals of the capacitors of the two corresponding nodes with the opposite polarity through the coupling resistor(s), and any two nodes in the network corresponding to negatively connected vertices on the graph (i.e., negative edge weight) are coupled in parallel connecting the terminals of the capacitors of the two corresponding nodes with the same polarity through the coupling resistor(s). This embodiment of the invention can be further modified consistent with any other networks, devices or methods described herein.

Another exemplary method for solving maximum-cut problems on a graph, can comprise: mapping vertices of the graph to nodes in a network of coupled circuit nodes; and mapping edge weights of the graph to coupling currents of the network, the network having: at least one node including: a capacitor where a voltage across the capacitor represents a state variable of the node and the voltage is converted to current before coupled to at least one other node in the network; and an active electronics element having two terminals connected in parallel with the capacitor supplying energy to the node, and the element having an odd-symmetric current-voltage characteristic exhibiting: a negative current gradient for voltages across its terminals that are below a predetermined threshold value in magnitude, and a positive gradient otherwise; and zero current for three voltage instances: zero volts, +V₁ volts, and −V₁ volts, where V₁ is a constant greater than the predetermined threshold. A coupling current between any two nodes in the network corresponding to two vertices on the graph is proportional to the edge weight between the two vertices; any two nodes in the network corresponding to positively connected vertices on the graph (i.e., positive edge weight) are cross-coupled such that the coupling current charges the capacitors of the two corresponding nodes with the opposite polarity; and any two nodes in the network corresponding to negatively connected vertices on the graph (i.e., negative edge weight) are coupled in parallel such that the coupling current charges the capacitors of the two corresponding nodes with the same polarity. This embodiment of the invention can be further modified consistent with any other networks, devices or methods described herein.

Another exemplary embodiment of the invention can comprise a device for solving maximum-cut problems on a graph, where vertices of the graph correspond to nodes in a network of resistively coupled circuit nodes and edge weights of the graph correspond to coupling resistors of the network, the network comprising: at least one node including: a capacitor where voltage across the capacitor represents a state variable of the node and the voltage is resistively coupled to at least one other node in the network; and an active electronics element having two terminals connected in parallel with the capacitor supplying energy to the node, and the element having an odd-symmetric current-voltage characteristic exhibiting: a negative current gradient for voltages across its terminals that are below a predetermined threshold value in magnitude, and a positive gradient otherwise; and zero current for three voltage instances: zero volts, +V₁ volts, and −V₁ volts, where V₁ is a constant greater than the predetermined threshold; a coupling resistor between any two nodes in the network corresponding to two vertices on the graph is inversely proportional to the edge weight between the two vertices; any two nodes in the network corresponding to positively connected vertices on the graph (i.e., positive edge weight) are cross-coupled connecting the terminals of the capacitors of the two corresponding nodes with the opposite polarity through the coupling resistor(s); and any two nodes in the network corresponding to negatively connected vertices on the graph (i.e., negative edge weight) are coupled in parallel connecting the terminals of the capacitors of the two corresponding nodes with the same polarity through the coupling resistor(s). This embodiment of the invention can be further modified consistent with any other networks, devices or methods described herein.

Yet another embodiment of the invention can comprise a device for solving maximum-cut problems on a graph where vertices of the graph correspond to nodes in a network of coupled circuit nodes and edge weights of the graph are correspond to coupling currents of the network, the network comprising: at least one node including: a capacitor where voltage across the capacitor represents a state variable of the node and the voltage is converted to current before coupled to at least one other node in the network; and a two-terminal active electronics element connected in parallel with the capacitor supplying energy to the node, and the element having an odd-symmetric current-voltage characteristic exhibiting: a negative current gradient for voltages across its terminals that are below a predetermined threshold value in magnitude, and a positive gradient otherwise; and zero current for three voltage instances: zero volts, +V₁ volts, and −V₁ volts, where V₁ is a constant greater than the predetermined threshold; a coupling current between any two nodes in the network corresponding to two vertices on the graph is proportional to the edge weight between the two vertices; any two nodes in the network corresponding to positively connected vertices on the graph (i.e., positive edge weight) are cross-coupled such that the coupling current charges the capacitors of the two corresponding nodes with the opposite polarity; and any two nodes in the network corresponding to negatively connected vertices on the graph (i.e., negative edge weight) are coupled in parallel such that the coupling current charges the capacitors of the two corresponding nodes with the same polarity. This embodiment of the invention can be further modified consistent with any other networks, devices or methods described herein.

### BRIEF DESCRIPTION OF THE DRAWINGS

Referring now to the drawings in which like reference numbers represent corresponding parts throughout:

FIG. 1 illustrates architecture of the exemplary bistable, resistively-coupled Ising machine (BRIM);

FIG. 2 illustrates an exemplary Nᵢ balanced BRIM node depicting connection between the Nᵢ node to two other nodes (Nⱼ and Nₖ);

FIG. 3 illustrates an exemplary balanced ZIV diode implemented with discrete components with polarity of the diode's terminals arbitrarily chosen;

FIG. 4 illustrates exemplary I-V curves of the balanced ZIV diode loaded with various load resistances R_{L} where the curves are obtained from the ZIV diode in FIG. 3;

FIG. 5 shows exemplary 6-nodes discrete BRIM implementation with LF412 opamps;

FIG. 6 shows exemplary voltage waveforms at the output of the nodes in the discrete BRIM of FIG. 5;

FIG. 7 illustrates a block diagram showing components of an exemplary BRIM having nodes Nᵢ and coupling units CUᵢⱼ;

FIG. 8 illustrates a balanced structure of an exemplary integrated circuit BRIM node which conceives to apply both the negative to positive coupling coefficients on the circuit; and

FIG. 9 illustrates an exemplary coupling unit circuit diagram.

### DETAILED DESCRIPTION OF THE PREFERRED EMBODIMENT

1. Ising Model

The Ising model is used to describe the Hamiltonian (the sum of the energies of a given system, e.g., kinetics and potential) of a system of spin. Though commonly called the Ising model, the model itself existed before Ernst Ising solved analytically a one-dimensional system. The model is a general one that describes a system with many nodes (e.g., atoms), each with a spin represented as σᵢ which takes only two values of +1 and −1. The energy of the system is a function of pair-wise coupling of the spins (Jᵢⱼ) and the interaction of some external field with each spin (hᵢ). The resulting Hamiltonian is as follows.

$$H = - {\sum }_{( i < j )} {J}_{ij} {σ}_{i} {σ}_{j} - μ {\sum }_{i} {h}_{i} {σ}_{i} . \qquad ( 1 )$$

If the external field is ignored, the Hamiltonian simplifies to

$$H = - {\sum }_{( i < j )} {J}_{ij} {σ}_{i} {σ}_{j} \qquad ( 2 )$$

This simplified version is more useful for the present application. Hereafter the Ising model or formula will be referenced as Eq. 2.

A physical system with such a Hamiltonian naturally tends towards low-energy states and thus serves as a convenient machine to solve a problem with a formulation equivalent to the Ising Hamiltonian—provided parameters (e.g., Jᵢⱼ) can be configured to match that of the problem.

2. Optimization Problems

A group of optimization problems naturally map to an Ising machine. Perhaps the most straightforward problem to map is Max-Cut. Given a graph G=(V, E), a cut is a partition of vertices into two sets of, say, V₁ and V₋₁ (V₁ U V₋₁=V, V₁∩V₋₁=Ø). The Max-Cut problem tries to find a cut such that the combined weight of the edges spanning the two vertices groups is maximum. In other words, the best cut is

$${argmax}_{( i , j ) ∈ E , i ∈ {V}_{i} , j ∈ {V}_{- 1}} \sum {W}_{IJ} \qquad ( 3 )$$

where Wᵢⱼ is the weight of edge (i, j). The resulting ΣWᵢⱼ will be referenced as the cut value.

It is easy to see the resemblance between Eq. 2 and 3. In fact, if the coupling weight (Jᵢⱼ) is set to be the negative of edge weight (−Wᵢⱼ) then the Ising Hamiltonian is simply the negative cut value plus a constant as follows:

$$H = {\sum }_{( i < j ) \vert {σ}_{i} = - {σ}_{j}} {W}_{i , j} {σ}_{i} {σ}_{j} + {\sum }_{( i < j ) \vert {σ}_{i} = {σ}_{j}} {W}_{i , j} {σ}_{I} {σ}_{j} = {\sum }_{( i < j ) \vert {σ}_{i} = - {σ}_{j}} {W}_{i , j} \times ( - 1 ) + {\sum }_{( i < j ) \vert {σ}_{i} = {σ}_{j}} {W}_{i , j} + {\sum }_{( i < j ) \vert {σ}_{i} = - {σ}_{j}} {W}_{i , j} - {\sum }_{( i < j ) \vert {σ}_{i} = - {σ}_{j}} {W}_{i , j} = {\sum }_{( i < j ) \vert {σ}_{i} = - {σ}_{j}} {W}_{i , j} \times ( - 2 ) + {\sum }_{( i < j )} {W}_{i , j} \qquad ( 4 )$$

Hence if the machine finds the ground state of the Hamiltonian, the max-cut is found. To find out the max-cut of an arbitrary graph is an NP-hard problem. Practical algorithms only operate to find a good answer. Similarly, existing Ising machines (including some present embodiments of the invention) are all Ising sampling machines that attempt to find a good answer with no guarantee of optimality.

Finally, it should be noted that here the only focus is on the Max-Cut problem when evaluating the present Ising machine design. This is because Max-Cut is NP-complete and thus all other NP-complete problems can be transformed as a Max-Cut problem with polynomial complexity. (See Karp, “Reducibility among Combinatorial Problems,” pages 85-103. Springer US, Boston, Mass., 1972, which is incorporated by reference herein.) This means other NP-complete problems can be solved with either additional pre- and post-processing time or with additional nodes for mapping. Both time and space overheads are bound by a polynomial complexity.

3. Quantum Mechanical and Optical Ising Machines

There are many natural systems that can be described by the Ising model. Take two existing systems with relatively large footprints for example. D-Wave's machine is a different style of quantum computers. Recent theoretical works have claimed the equivalence between quantum annealers and the more traditional circuit model quantum computing. (See Yu, et al., “Exact equivalence between quantum adiabatic algorithm and quantum circuit algorithm,” Chinese Physics Letters, 35(11):110303, October 2018; and Dam et al., “How powerful is adiabatic quantum computation?,” Proceedings 2001 IEEE International Conference on Cluster Computing, pages 279-287, 2001, which are incorporated by reference herein.) In this machine, D-Wave uses superconducting qubits as the basic building block. These bits are then coupled together with couplers forming a connection topology known as the Chimera graph. This is an important architectural constraint that limits the typology of the problem that can be mapped to the machine. In practice, an abstract problem has to go through a transformation (called minor embedding) to ensure that it can be mapped to the machine. This process involves mapping a logical node onto multiple physical nodes that are themselves coupled together strongly. In this way, in solutions found they are almost always spinning in the same direction that they can be considered as one logical node. It will be shown that this limits the number of effective nodes (spins) that a machine can offer. Considering an extreme example of fully connected graph, the number of nodes needed in the minor embedded version grows quadratically with the number of logical nodes. Another disadvantage of the system is the cryogenic operating condition (at 15 mK) needed for the quantum annealer. This requirement consumes a significant portion of the 25 KW power of the machine.

Coherent Ising machines (CIMs) are another recent example of Ising sampling machines. (See Inagaki et al., “A coherent Ising machine for 2000-node optimization problems,” Science, 354, 10 2016, which is incorporated by reference herein.) In a CIM, an optical device called OPO (optical parametric oscillator) is used to generate and manipulate the signal to represent one spin. Unlike in a D-Wave machine, the coupling between spins is relatively straightforward in principle. As a result CIM implementations have always supported all-to-all coupling. It should be emphasized that the 2000-node CIM is therefore far more capable than D-Wave 2000Q which can only map problem size of 64 (or 61 after discounting defective nodes). (See Hamerly et al., “Experimental investigation of performance differences between coherent Ising machines and a quantum annealer,” In Science advances, 2019, which is incorporated by reference herein.) In practice, not all problems of actual interest are on complete graphs, so the capability difference is perhaps less extreme. CIM is not without its disadvantages, to support 2000 spins, kilometers of fibers are needed. Temperature stability of the system is thus an acute engineering challenge. Efforts to scale beyond the currently achieved size (of about 2000) have not been successful as the system runs into stability problems. Also worth noting is that the coupling between nodes is—at least in the current incarnation—implemented via computation external to the optical cavity. Every pulse's amplitude and phase are detected and its interaction with all other pulses calculated on an auxiliary computer (FPGA) and in turn used to modulate new pulses that are injected into the cavity. Strictly speaking, the current implementation is a nature-simulation hybrid Ising machine. Thus, beyond the challenge of constructing the cavity, CIM also requires a significant supporting structure that involves fast conversions between optical signal and electrical signals and a rather intensive computational demand (e.g. 100s of GFLOPS).

These room-sized Ising machines may certainly be worthwhile creations for the sake of science. In particular, both models have some theoretical underpinning for reaching the groundstate solution (i.e., the best solution). However, as shall be shown hereafter, practical designs do not guarantee reaching the ground state. As a practical computing platform, both models have significant room for improvements.

4. Electronic Oscillator-Based Ising Machines

A network of coupled oscillators is another physical implementation of an Ising machine. Take a network of coupled oscillators as an example. After sufficient time, the oscillators will synchronize forming stable relative phase relationship. (The observation of such synchronization dates back to at least the 17^{th} century when Huygens observed synchronization of two pendulums. See Rosenblum et al., “Phase synchronization of chaotic oscillators,” Physical review letters, 76(11):1804, March 1996, incorporated by reference herein. Synchronization phenomenon is the subject of research efforts in a wide variety of fields. Large-scale synchronization of firefly flashings and rhythmic applause in a large crowd of audiences are but two examples in the general underlying principles beyond mechanical objects.) While many factors (e.g., amplitude, stochastic noise) can influence the phase of each oscillator, the following formula is a simplified steady-state description of phase relationship.

$$\frac{d}{dt} {ϕ}_{i} ( t ) = {\sum }_{j = 1}^{N} {J}_{ij} sin ( {ϕ}_{j} ( t ) - {ϕ}_{i} ( t ) ) \qquad ( 5 )$$

Note that this simplified model ignored certain elements (e.g., diffusion due to noise) and is thus an approximation of a more complicated reality. Given such a differential equation describing a dynamic system, it can be shown that a Lyapunov function in the following form exists:

$$H ( Φ ( t ) ) = - {\sum }_{i < j} {J}_{ij} cos ( {ϕ}_{j} ( t ) - {ϕ}_{i} ( t ) ) \qquad ( 6 )$$

This means that the system will generally evolve along a trajectory that minimizes the Lyapunov function. In other words, if a network of coupled oscillators is built with certain coupling strengths (Jᵢⱼ), the system's stable states represent good solutions that minimizes the right hand side Eq. 6.

On a closer inspection, the resemblance of Eq. 6 and the Ising model (Eq. 2) is seen. Specifically, when all phases (ϕᵢ) are all 0 or π, the two formulae are the same. Indeed, the formulation of Eq. 6 is similar to the classic XY spin model where each spin can point to any direction along an “XY” plane and thus can be represented by a phase (ϕᵢ). Ising model is thus a special case of the XY model. In other words, a system of coupled oscillators form an “XY machine” (not an Ising machine). An XY state can be quantized into an Ising state (ϕᵢ=0, π) in a number of different ways. For the purposes of this disclosure, direct quantization which rounds the phase to the nearest multiple of it can be considered.

A number of oscillator-based Ising machines have been recently proposed. (See Wang et al., “OIM: oscillator-based Ising machines for solving combinatorial optimisation problems,” CoRR, abs/1903.07163, 2019, which is incorporated by reference herein.) However, all these examples use LC tank oscillators. While this is a common practice for analog circuit designers and relatively straightforward for discrete-element prototypes, the use of LC tanks introduces non-trivial practical challenges in integrated circuit (IC) designs. The lack of high quality inductors and the usually high area costs of incorporating them are common challenges for integrated RF circuitry. These desktop Ising machines are a significantly smaller that other room-sized Ising machines. But for genuine wide-spread applications, a clean-slate IC-focused Ising machine design is a valuable pursuit. There can be significant cross-pollination of different approaches and future practice may very well be a confluence of the three (or more) styles of Ising machines.

5. Simulated Sampling Machine

While a physical substrate Ising machine is undoubtedly fast and efficient, an Ising machine can be emulated by a conventional machine. Indeed, the classical technique of simulated annealing is a good example. (See Kirkpatrick et al., “Optimization by simulated annealing,” Science, 220(4598):671-680, 1983, which is incorporated by reference herein.) The principles behind simulated annealing has been broadly adopted in a variety of algorithms from Hopfield network to Boltzmann machines. One most relevant example is a recent CMOS design using traditional memory and relatively simple logic specifically to accelerate simulated sampling. (See Yamaoka et al., “24.3 20 k-spin ising chip for combinational optimization problem with cmos annealing,” 2015 IEEE International Solid-State Circuits Conference—(ISSCC) Digest of Technical Papers, pages 1-3, February 2015; and Takemoto et al., “2.6 a 230 k-spin multichip scalable annealing processor based on a processing-in-memory approach for solving large-scale combinatorial optimization problems,” IEEE International Solid-State Circuits Conference, February 2019, which are incorporated by reference herein.) In these machines, there is no physical mechanism that naturally guides the system states towards some energy ground state, instead, the energy difference is calculated, and state transition is probabilistically determined. It is worth noting that the present design does not follow popular annealing approach but uses its own heuristics (which could be thought of as a simplified Metropolis heuristic): accept a new state when energy is lower, apply random changes following a linear annealing schedule.

6. CMOS IC Ising Machines

This section describes a broad outline for embodiments of the present invention and then uses a small discrete component implementation as a concrete example of a functioning system and proceeds to describe a chip-scale design.

As previously discussed, existing Ising machine designs have different strengths and weaknesses. The room-sized machines are good vehicles for continued scientific exploration of the underlying principles. But at the moment, they have no tangible benefits for immediate application. Electronic, oscillator-based Ising machines have already showed good problem solving capabilities but present real technical challenges for IC implementations. For example, a machine requiring an LC-tank in each node for its operation might not be suitable for integration in advanced CMOS technologies due to challenges associated with inductor scaling. Even though it is possible to scale an on-chip inductors to smaller sizes in theory, this comes at the expense of requiring higher resonant frequencies (e.g., GHz range). A large-scale Ising machine necessarily contains many nodes spread over long distances with concomitant parasitics of the interconnect lines. Proper coupling at such high operating frequencies while preserving phase coherence presents a real engineering challenge, if possible at all. In addition, it might be difficult to achieve purely resistive coupling of oscillator at GHz operating frequencies. Hence, it is desirable to explore an IC-focused designs that have good performance characteristics and easy for CMOS integration.

There are perhaps many different approaches to the design of Ising machine. Embodiments of the present invention can be described beginning with a simple intuitive foundation. In the Ising model, when two nodes (e.g. i, and j) are strongly and positively coupled (i.e., Jᵢⱼ is large and positive) their spins are likely to be parallel (σᵢ=σⱼ). In this way, the term −Jᵢⱼσᵢσⱼ will contribute to lowering the energy. Conversely, a strong negative coupling (Jᵢⱼ is large and negative) will likely lead to anti-parallel spins (σᵢ=−σⱼ). Finally, weak coupling (Jᵢⱼ is small) suggests that the two spins are more likely to be independent.

This behavior can be easily mimicked with resistively coupled capacitors. Consider representing a node with capacitors in a differential manner where the polarity of the voltage represent the spin of the node. Nodes can then be connected with different conductance/resistance. A strong coupling means a high conductance (i.e. lower resistor) value so that voltages of two nodes can more easily equilibrate. The sign of coupling can also be achieved with connecting either the same or opposite polarity in the differential circuit. Once initialized with random voltages, these coupled capacitors can indeed seek some temporary equilibrium—temporary because the energy stored in the capacitors will eventually dissipate through the coupling resistors and all nodes will decay to value 0, rather than staying at the desired ±1. To induce and maintain the nodes at ±1, a local feedback unit can be introduced to make the node voltages bistable. Such a bistable, resistively-coupled Ising machine can be referenced as BRIM.

To show that this is a viable approach, a concrete example using discrete components can now be described before exploring the principle behind the operations and the characteristics of some circuit elements that are needed for the machine to function as expected. A detailed architecture and circuit design of a complete Ising machine for integrated circuit will be described hereafter.

7. Example Ising Machine Design with Discrete Electronics

An exemplary implementation of the BRIM in discrete electronics with operational amplifiers is described here with passive components such as capacitors as well as resistors. The exemplary BRIM of Ising machine can employ a design using nodes with a single state variable (e.g., voltage on a capacitor) whose trajectories obey first order ordinary differential equations. In order to derive a suitable first order phase-space model, a Lyapunov function can be used of the form shown in Eq. (7), where v(t)=[V₁(t)V₂(t) . . . V_{N}(t)]^{T} and P(Vᵢ(t)) is a double-well potential energy term (e.g., a differentiable function having two equal minima at V₁(t)=−1V and Vᵢ(t)=+1V and a saddle point at Vᵢ(t)=0V.

$$H ( v ( t ) ) = - {\sum }_{i < j} {J}_{ij} {V}_{j} ( t ) {V}_{i} ( t ) - {ϕ}_{i} ( t ) ) + {\sum }_{i} {J}_{i} P ( {V}_{i} ( t ) ) \qquad ( 7 )$$

A sufficient condition for monotonic convergence of the Lyapunov function in Eq. (7) to a minimum stable point (i.e.,

$$\frac{{d}^{″} H ( \dot{v} ( t )}{dt} \leq 0 )$$

is achieved if all state variables Vi(t) obey the following differential equation.

$$\frac{{dV}_{i}}{dt} = {\sum }_{j = 1 , j \neq i}^{N} {J}_{ij} {V}_{j} - {J}_{i} \frac{dP ( {V}_{i} )}{dt} \qquad ( 8 )$$

The Lyapunov function in Eq. (7) is a continuous function in an N-dimensional space whose global minimum might not map to the global minimum of the discrete N-dimensional space Ising Hamiltonian −Σ_{(i<j)}J_{i,j}σᵢσⱼ. A proper choice of coupling terms Jᵢⱼ and Jᵢ as well as a proper choice of an annealing schedule allowing the coupling terms to vary over time, the second term in Eq. (7) will force the continuous states to bifurcate into one of the stable equilibrium points (e.g., −1 V and +1V) corresponding to the two spin values in the Ising Hamiltonian and collapsing the continuous Lyapunov function in Eq. (7) into a ground energy state of the corresponding (sing Hamiltonian form.

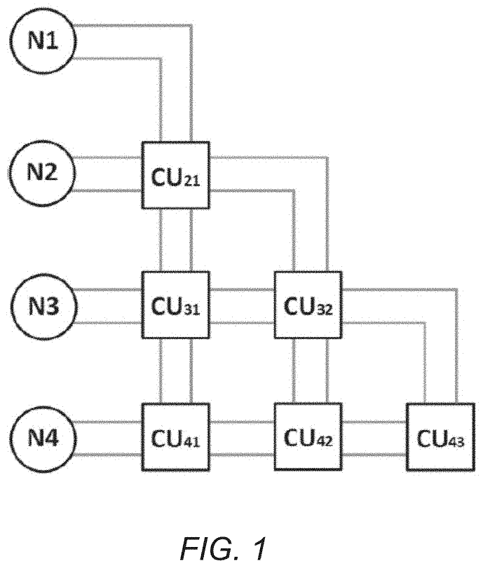

FIG. 1 shows the topology overview of a discrete BRIM. At the heart of the present discrete implementation system is an array of bi-stable nodes (e.g., Nᵢ, i=1; 2, . . . N) coupled through a mesh of all-to-all resistive coupling network with coupling units CUᵢⱼ. Each bistable node Nᵢ provides a differential output (e.g., vᵢ⁺ and vᵢ⁻) to the mesh of coupling units. Each coupling unit CUᵢⱼ has a pair of resistors Rᵢⱼ connecting the differential outputs from two nodes (e.g., Nᵢ and Nⱼ). For positive coupling coefficients Jᵢⱼ, the positive output vᵢ⁺ from node Nᵢ is coupled to the positive node vⱼ⁺ from node Nⱼ and the negative output vᵢ⁻ is coupled to vⱼ⁻. Alternatively, for negative coupling coefficients Jᵢⱼ, the differential outputs from nodes Nᵢ and Nⱼ are crosscoupled. The resistor values in the coupling units are set to Rᵢⱼ=R_{C}/Jᵢⱼ, where R_{C} is a constant resistance whose value is chosen appropriately to allow each node to converge to one of its bi-stable states.

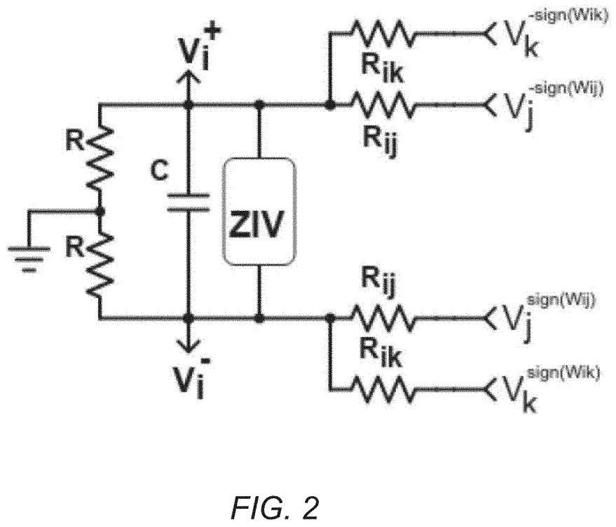

FIG. 2 illustrates an exemplary circuit for a bi-stable node Nᵢ implemented with discrete electronic components for use under the topology of FIG. 1. The Nᵢ balanced BRIM node has connection between the Nᵢ node to two other nodes (Nⱼ and Nₖ). The circuit comprises one energy storage element (capacitor C) giving rise to a state variable vᵢ(t) whose trajectory is described by an ordinary differential equation as shown in Eq. 9.

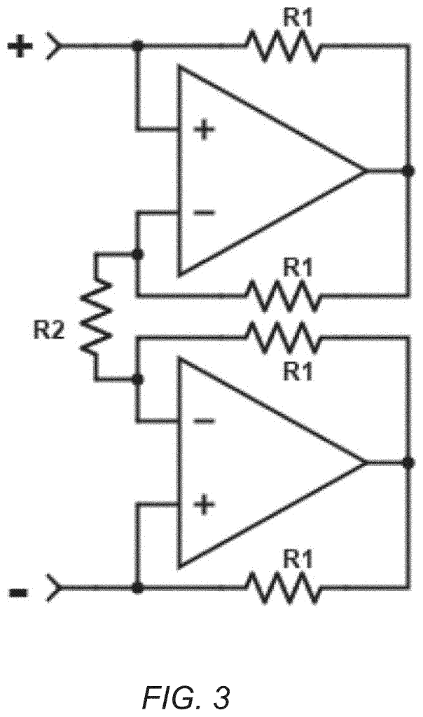

FIG. 3 shows an exemplary balanced ZIV diode implemented with two operational amplifiers which can be incorporated in to the exemplary circuit of FIG. 2. The balanced ZIV diode can be implemented with discrete components with polarity of the diode's terminals arbitrarily chosen.

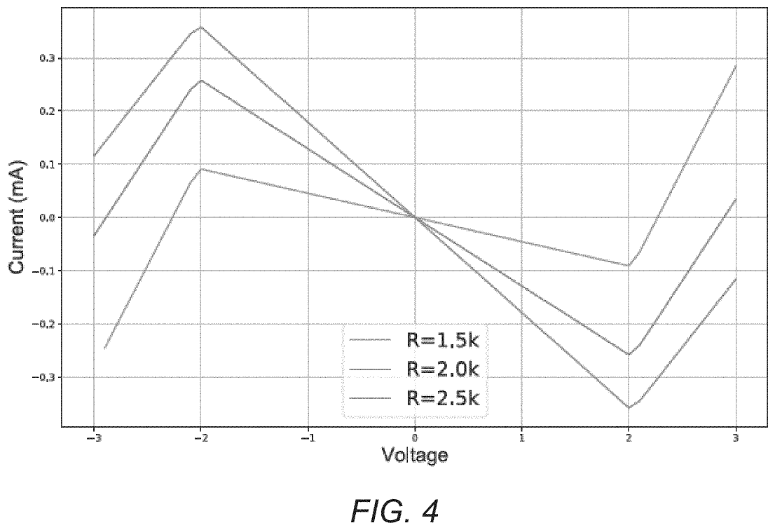

FIG. 4 shows example I-V curves of the ZIV diode's i=g_{D}(v). The I-V curves of the balanced ZIV diode are shown loaded with various load resistances R_{L}. The curves are obtained from the ZIV diode in FIG. 3, where R₁=9.1 k, R₂=2.6 k, and LF₄₁₂ opamps powered at +/−9V. The I-V curve has three equilibrium points (i=0) including the unstable one at the origin (i=0 and v=0) and two stable equilibrium points (e.g., v=−2.3V and v=+2.3V for load resistance of 1.5K) giving rise to the bi-stable behaviour of the BRIM nodes.

$${\dot{v}}_{i} = \frac{1}{2 C} ( {\sum }_{j = 1 , j \neq i}^{N} \frac{- sign ( {w}_{ij} )}{{R}_{ij}} {v}_{j} + … - {v}_{i} ( \frac{1}{R} + {\sum }_{j = 1 , j \neq i}^{N} \frac{1}{{R}_{ij}} ) - {g}_{D} ( 2 {v}_{i} ) ) \qquad ( 9 )$$

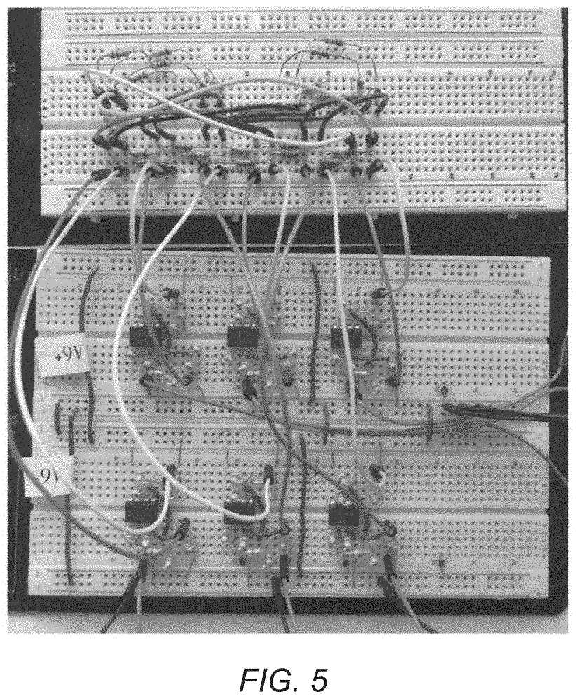

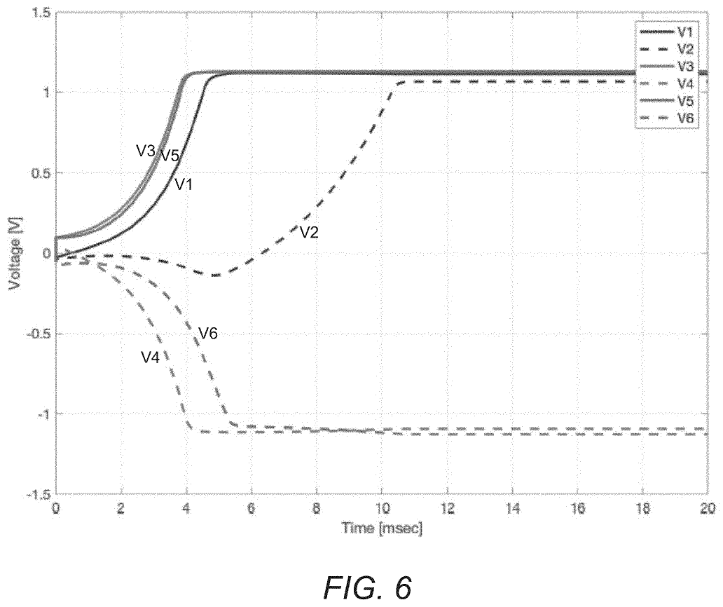

FIG. 5. illustrates an example discrete BRIM prototype implementing six bistable nodes from the described circuit elements of FIGS. 2 and 3. FIG. 6 shows voltages vᵢ(t) converge to one of the stable states after the circuit is powered up, depicting voltages from the exemplary embodiment of FIG. 5.

The exemplary voltage waveforms of FIG. 6 are shown at the output of the nodes in the discrete BRIM of FIG. 5. The output voltages from nodes N₁, N₂, N₃, and N₅ converge to +1.15V representing an “UP” spin, while voltages from nodes N₄, and N₆ converge to −1.15V representing “DOWN” spin. After the completion of the convergence, the voltages are compared against a threshold of 0V to measure a polarity and the results is presented as “spin” values to the user to determine the maximum-cut solution of the corresponding graph.

8. Architecture of an Exemplary BRIM Integrated Circuit Design

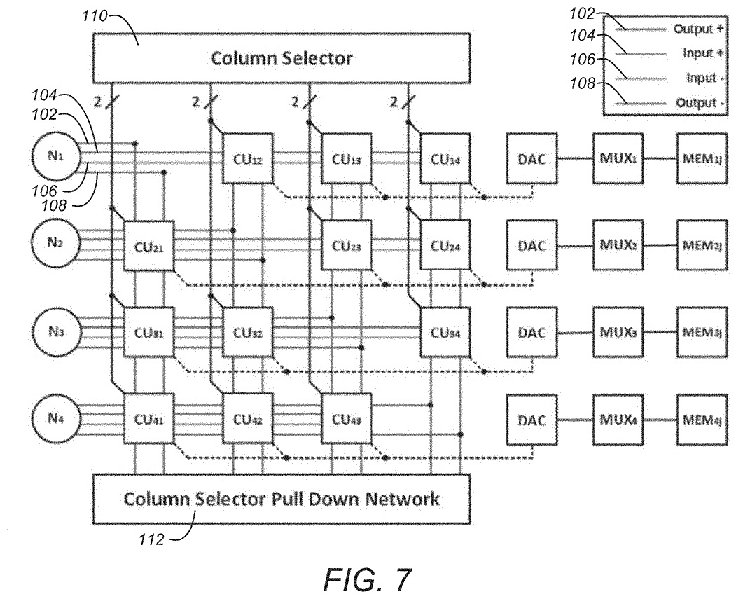

An exemplary implementation of the BRIM in CMOS integrated circuit technologies is described here. While this design shares a general structure with the simplified example using discrete components, a number of variations are introduced that can be useful in improving the system's flexibility. FIG. 7 illustrates an exemplary BRIM system (having nodes Nᵢ and coupling units CUᵢⱼ), which can be implemented in CMOS, defined by a group of components as follows:

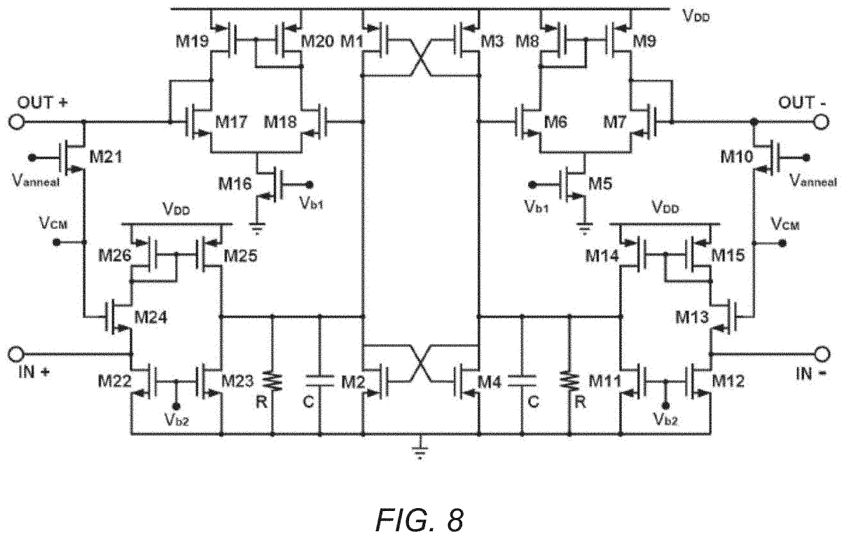

Nodes and couplers: At the left of FIG. 7 are the bistable nodes, N₁, N₂, N₃, and N₄. Each of the bistable nodes N₁, N₂, N₃, and N₄ contains a pair of capacitors, two resistors, and a special diode to form a bi-stable, differential Ising node with two differential terminals (Vᵢ⁺ and Vᵢ⁻), across terminals Out+ 102 and In+ 104 and Out− 106 and In− 108, respectively. FIG. 8 shows an exemplary transistor level implementation of an integrated bistable node with the four terminals, Out+ 102 and In+ 104 and Out− 106 and In− 108. Each of the bistable nodes are connected to each other from their terminals through a network of coupling units (CUᵢⱼ, where i=1 to 4 and j=1 to 4, excluding i=j) each with four terminals, two connected to two input nodes and two to the output nodes. Note here that the coupling is directed/unidirectional: this is achieved with a buffer (e.g., transistors M5 to M9 in FIG. 8). In principle, an undirected/bidirectional coupling has similar effects. But empirically, directed coupling produces better solution quality at the expense of increased circuit area.

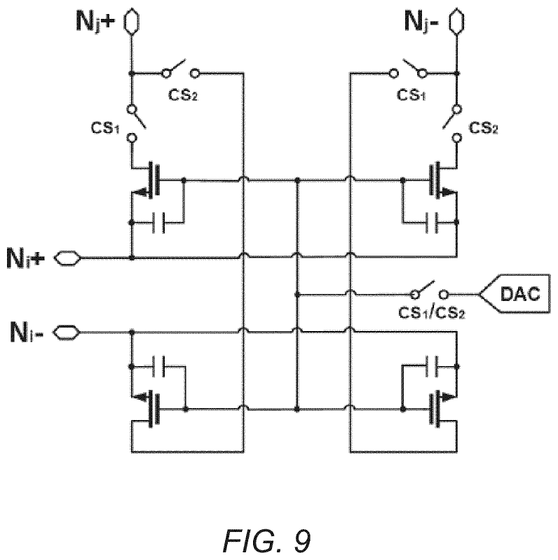

Programming units: The resistance of the coupling is programmable. FIG. 9 shows an exemplary coupling unit circuit diagram using a transistor with adjustable gate voltage to achieve programmable resistance. To the right of the coupling unit array in FIG. 7 is the programming array, coupled to each string of i coupling units CUᵢⱼ. This array comprises digital memory (MEM for storing the weights which drives an array of digital-to-analog converters (DACs) through multiplexors MUX₁ to MUX₄. A small number of such DACs are sufficient to program all the coupling units in a time-interleaved fashion. In the figure, NDACs are shown programming the N×(N−1) coupling units. In such a configuration, corresponding column selectors 110 and pulldown logic 112 are needed which are shown above and below the coupling units CUᵢⱼ.

Annealing scheduler: The coupling strength is adjustable over time for annealing. Exponential annealing is used both because it can be conveniently achieved using a discharging capacitor as the global annealing scheduler. The annealing operation in this example IC design is achieved by the transistors M10 and M21 in FIG. 8 whose gate biasing voltage sets their channel resistance which then loads the buffers and reduces the buffer's gain and the overall coupling strength. For example, setting Vₐₙₙₑₐₗ to high value will lower the gain of the buffer to almost zero, therefore, eliminating coupling to other nodes altogether. Conversely, setting Vₐₙₙₑₐₗ to zero volts will allow maximum gain from the buffers and maximum coupling strength limited only by the coupling units. At the end of the annealing, the state of the nodes will be read out from the nodes. With the stable voltage adjusted appropriately, the read out can be achieved with a simple flip-flop.

Perturbation unit Finally, it is useful to have the ability to flip the state of a selected node. This gives the system the ability to escape the current basin of attraction. Note that this is a form of introducing perturbation. An alternative is to add circuit level noise. While both can achieve similar results, introducing analog noise is more difficult to control and leads to more discrepancies between simulation and actual hardware.

The described exemplary BRIM can be used similarly to other Ising machines: first programming the weights; then selecting the annealing length; and finally reading out the state of the nodes. With the elements described, the system can be used in a number of different ways: e.g. the annealing time can be adjusted; the perturbation unit can be turned on with different frequency; the machine can be used with a software-based search algorithm (e.g., simulated annealing).

This concludes the description including the preferred embodiments of the present invention. The foregoing description including the preferred embodiment of the invention has been presented for the purposes of illustration and description. It is not intended to be exhaustive or to limit the invention to the precise forms disclosed. Many modifications and variations are possible within the scope of the foregoing teachings. Additional variations of the present invention may be devised without departing from the inventive concept as set forth in the following claims.

What is claimed is:

1. A network of resistively coupled circuit nodes comprising:
at least one node including:
a capacitor where a voltage across the capacitor represents a state variable of the node and the voltage is resistively coupled to at least one other node in the network; and
an active electronics element having two terminals connected in parallel with the capacitor supplying energy to the node, the active electronics element having an odd-symmetric current-voltage characteristic exhibiting:
a negative current gradient for voltages across the two terminals that are below a predetermined threshold value in magnitude, and a positive gradient otherwise; and
zero current for three voltage instances: zero volts, +V₁ volts, and −V₁ volts, where V₁ is a constant greater than the predetermined threshold.

2. The network of claim 1, wherein a programmable resistor is connected in parallel with the active electronics element to adjust the negative current gradient and the positive current gradient in the odd-symmetric current-voltage characteristic and V₁.

3. The network of claim 1, wherein a bipolar junction transistor is connected in parallel with the active electronics element to adjust the negative current gradient and the positive current gradient in the odd-symmetric current-voltage characteristic and V₁ by changing a base current of the bipolar junction transistor.

4. The network of claim 1, wherein a field-effect transistor is connected in parallel with the active electronics element to adjust the negative current gradient and the positive current gradient in the odd-symmetric current-voltage characteristic and V₁ by changing a gate voltage of the field-effect transistor.

5. A network of coupled circuit nodes comprising:
at least one node including:
a capacitor where a voltage across the capacitor represents a state variable of the node and the voltage is converted to current before being coupled to at least one other node in the network; and
an active electronics element having two terminals connected in parallel with the capacitor supplying energy to the node, and the element having an odd-symmetric current-voltage characteristic exhibiting:
a negative current gradient for voltages across the two terminals that are below a predetermined threshold value in magnitude, and a positive gradient otherwise; and
zero current for three voltage instances: zero volts, +V₁ volts, and −V₁ volts, where V₁ is a constant greater than the predetermined threshold.

6. The network of claim 5, wherein a programmable resistor is connected in parallel with the active electronics element to adjust the negative current gradient and the positive current gradient in the odd-symmetric current-voltage characteristic and V₁.

7. The network of claim 5, wherein a bipolar junction transistor is connected in parallel with the active electronics element to adjust the negative current gradient and the positive current gradient in the odd-symmetric current-voltage characteristic and V₁ by changing a base current of the transistor.

8. The network of claim 5, wherein a field-effect transistor is connected in parallel with the active electronics element to adjust the negative current gradient and the positive current gradient in the odd-symmetric current-voltage characteristic and V₁ by changing a gate voltage of the transistor.

9. A method for solving maximum-cut problems on a graph comprising:
mapping vertices of the graph are to nodes in a network of resistively coupled circuit nodes; and
mapping edge weights of the graph to coupling resistors of the network, the network having:
at least one node including:
a capacitor where a voltage across the capacitor represents a state variable of the node and the voltage is resistively coupled to at least one other node in the network,
an active electronics element having two terminals connected in parallel with the capacitor supplying energy to the node, and the active electronics element having an odd-symmetric current-voltage characteristic exhibiting:
a negative current gradient for voltages across the two terminals that are below a predetermined threshold value in magnitude, and a positive gradient otherwise; and
zero current for three voltage instances: zero volts, +V₁ volts, and −V₁ volts, where V₁ is a constant greater than the predetermined threshold;
a coupling resistor between any two nodes in the network corresponding to two vertices on the graph is inversely proportional to the edge weight between the two vertices;
any two nodes in the network corresponding to positively connected vertices on the graph are cross-coupled connecting to the capacitors of the two corresponding nodes with the opposite polarity through the coupling resistor; and
any two nodes in the network corresponding to negatively connected vertices on the graph are coupled in parallel connecting the capacitors of the two corresponding nodes with the same polarity through the coupling resistor.

10. A method for solving maximum-cut problems on a graph, comprising:
mapping vertices of the graph to nodes in a network of coupled circuit nodes; and
mapping edge weights of the graph to coupling currents of the network, the network having:
at least one node including:
a capacitor where a voltage across the capacitor represents a state variable of the node and the voltage is converted to current before coupled to at least one other node in the network; and
an active electronics element having two terminals connected in parallel with the capacitor supplying energy to the node, and the element having an odd-symmetric current-voltage characteristic exhibiting:
a negative current gradient for voltages across the two terminals that are below a predetermined threshold value in magnitude, and a positive gradient otherwise; and
zero current for three voltage instances: zero volts, +V₁ volts, and −V₁ volts, where V₁ is a constant greater than the predetermined threshold;
a coupling current between any two nodes in the network corresponding to two vertices on the graph is proportional to the edge weight between the two vertices;
any two nodes in the network corresponding to positively connected vertices on the graph are cross-coupled such that the coupling current charges the capacitors of the two corresponding nodes with the opposite polarity; and
any two nodes in the network corresponding to negatively connected vertices on the graph are coupled in parallel such that the coupling current charges the capacitors of the two corresponding nodes with the same polarity.

11. A device for solving maximum-cut problems on a graph, where vertices of the graph correspond to nodes in a network of resistively coupled circuit nodes and edge weights of the graph correspond to coupling resistors of the network, the network comprising:
at least one node including:
a capacitor where voltage across the capacitor represents a state variable of the node and the voltage is resistively coupled to at least one other node in the network; and
an active electronics element having two terminals connected in parallel with the capacitor supplying energy to the node, and the element having an odd-symmetric current-voltage characteristic exhibiting:
a negative current gradient for voltages across the two terminals that are below a predetermined threshold value in magnitude, and a positive gradient otherwise; and
zero current for three voltage instances: zero volts, +V₁ volts, and −V₁ volts, where V₁ is a constant greater than the predetermined threshold;
where a coupling resistor between any two nodes in the network corresponding to two vertices on the graph is inversely proportional to the edge weight between the two vertices;
where any two nodes in the network corresponding to positively connected vertices on the graph are cross-coupled connecting the terminals of the capacitors of the two corresponding nodes with the opposite polarity through the coupling resistor; and
where any two nodes in the network corresponding to negatively connected vertices on the graph are coupled in parallel connecting the capacitors of the two corresponding nodes with the same polarity through the coupling resistor.

12. A device for solving maximum-cut problems on a graph where vertices of the graph correspond to nodes in a network of coupled circuit nodes and edge weights of the graph are correspond to coupling currents of the network, the network comprising:
at least one node including:
a capacitor where voltage across the capacitor represents a state variable of the node and the voltage is converted to current before coupled to at least one other node in the network; and
a two-terminal active electronics element connected in parallel with the capacitor supplying energy to the node, and the element having an odd-symmetric current-voltage characteristic exhibiting:
a negative current gradient for voltages across the two terminals that are below a predetermined threshold value in magnitude, and a positive gradient otherwise; and
zero current for three voltage instances: zero volts, +V₁ volts, and −V₁ volts, where V₁ is a constant greater than the predetermined threshold;
where a coupling current between any two nodes in the network corresponding to two vertices on the graph is proportional to the edge weight between the two vertices;
where any two nodes in the network corresponding to positively connected vertices on the graph are cross-coupled such that the coupling current charges the capacitors of the two corresponding nodes with the opposite polarity; and
where any two nodes in the network corresponding to negatively connected vertices on the graph are coupled in parallel such that the coupling current charges the capacitors of the two corresponding nodes with the same polarity.
